(19) United States
(12) Patent Application Publication
(10) Pub. No.: US 2014/0086772 A1
(43) Pub. Date: Mar. 27, 2014

(54) ACTUATOR ELEMENT AND AN ACTUATOR FOR GENERATING A FORCE AND/OR A MOVEMENT

(71) Applicant: Jan Olsen, Soenderborg (DK)

(72) Inventor: Jan Olsen, Soenderborg (DK)

(21) Appl. No.: 13/984,627

(22) PCT Filed: Feb. 22, 2012
(86) PCT No.: PCT/DK2012/000017

§ 371 Date: Dec. 16, 2013

(30) Foreign Application Priority Data
Feb. 23, 2011 (DK) PA 2011 00123

(51) Int. Cl. F03G 7/06; F16F 7/00; F04B 53/00

(52) U.S. Cl. CPC F03G 7/065; F04B 53/00; F16F 7/00
USPC 417/510; 60/527; 267/140.11

(57) ABSTRACT

The present invention concerns an actuator element (1) for generating a force and/or a movement, the element (1) comprising at least one cylindrical rubber part (4), at least one helical spring (3) and at least one SMA wire wound to a helical shape (2), the cylindrical rubber part (4) having in its longitudinal direction a cylindrical cavity, the helical spring (3) and the wound SMA wire (2) being arranged around the cylindrical cavity. The invention relates furthermore to a liquid pump, an actuator and a vibration damper for damping vibration comprising an actuator element according to the invention.

### CROSS REFERENCE TO RELATED APPLICATIONS

This application is entitled to the benefit of and incorporates by reference subject matter disclosed in its entirety in International Patent Application No. PCT/DK2012/000017 filed on Feb. 22, 2012 and Danish Patent Application No. PA 2011 00123 filed Feb. 23, 2011.

### FIELD OF THE INVENTION

The present invention concerns an actuator element comprising an SMA wire embedded in rubber. The invention further concerns an actuator containing the actuator element. The actuator element can be used for generating a force and/or a movement.

### BACKGROUND OF THE INVENTION

In English literature, shape memory alloys are referred to by the abbreviation SMA. SMA represents a group of metal alloys having the property of “remembering” a shape, meaning that they are able to revert to a predefined shape when heated above the phase transformation temperature. This property occurs because a transformation takes place in the crystallographic structure of the alloy between two phases, a low-temperature phase (martensitic) and a high-temperature phase (austenitic). The martensitic and the austenitic phases have the same chemical composition but two different crystallographic structures. If an SMA is deformed, when it is in its martensitic phase, the deformation can be removed again by heating the SMA until it transforms to the austenitic phase, where the SMA regains its original shape. This property can advantageously be used when designing actuators and other devices by “programming” the SMA to “remembering” a certain shape in its austenitic phase.

For use in linear actuators, SMA is commercially available in the form of a pre-drawn martensitic wire that is “programmed” to remembering a shorter length during heating. When the wire is heated above the transformation temperature, a transformation to the austenitic phase will take place, whereby the wire is shortening. During transformation, the wire can generate a very large force when meeting an external resistance. When the wire is cooled off below the transformation temperature, it will revert to the martensitic phase, whereby the wire becomes soft. If, during transformation back to the martensitic phase, the wire is influenced by a biasing force, it will revert to its original length. This biasing force may, for example, be provided by the gravity, a spring, a magnetic force or another SMA wire.

Actuators based on SMA have been used in commercial products since the 1970'es. One of the first descriptions of such actuators in the patent literature appears from the American patent U.S. Pat. No. 3,403,238. Other examples of devices using SMA in connection with actuators are described in U.S. Pat. No. 7,021,055, U.S. Pat. No. 6,326,707, U.S. Pat. No. 6,574,958, U.S. Pat. No. 4,841,730 and U.S. Pat. No. 5,172,551.

There are three groups of commercially available SMA, namely NiTi-, CuAl- and FeMn-alloys. Of these, the NiTi-alloys are the most dominating in the commercial market because of their large shape memory effect and their mechanical and chemical properties. The difference in the lengths of a NiTi SMA wire in the martensitic phase and the austenitic phase can be up to 8%, but typically is 5%. NiTi SMA are commercially available with phase transformation temperatures in the interval −100° C. to 110° C., where 36° C., 70° C. and 90° C. being the most frequently used transformation temperatures.

The shape memory can be “programmed” into SMA materials by means of a suited thermal procedure. The procedure comprises shaping the material and maintaining the material in the desired shape, for example by means of a fixture, and then submitting it to a heat treatment at a specific temperature and for a certain time interval, while it is held in the fixture. For NiTi SMA a temperature of 500° C. for five minutes is used. The NiTi SMA wire shape is relatively easily “programmed”, as it can take place continuously, for example as a partial process in a tube furnace during drawing of the wire, and will there-fore not contribute significantly to the price of the wire. If the shape is a little more complex, for example a helical spring, the cost of the thermal procedure is so high that in practice a mass production of such a component will not be economical.

There are two methods of heating SMA for activation of the shape memory effect, one being thermal heating through the surface and the other being joule heating by directing current directly through the material, for example the SMA wire.

In an actuator using NiTi SMA wire, where the activation of the shape memory effect takes place by means of joule heating, the design of the electrical connection of the wire ends is often a technical challenge. NiTi wire is very difficult to weld; other joining methods, for example soldering, gluing with electrically conducting glue or crimping can be used, but over time the wire tends to work itself loose because of the large shape change occurring during the phase transformation of the SMA wire. If the actuator fails after a number of activations, one of the typical reasons is that the SMA wire has broken at or has worked itself loose at the electrical connections.

When using SMA wire in an actuator using joule heating the practical problem appears that it is necessary to encapsulate the wire, as the wire can become very hot, >100° C., and at the same time it is conducting an electrical current.

### SUMMARY

In the present invention, the term “a wound SMA wire” shall mean an SMA wire that is programmed to assume a straight shape and at the same time to contract, when heated above its phase transformation temperature. The SMA wire is wound to an approximately helical shape and retained in the helical shape by being embedded in rubber. The SMA wire will not straighten itself to the straight shape as long as the rubber retains the SMA wire in an approximately helical shape. In the axis-symmetric helical shape, the forces generated, when the SMA wire attempts to straighten itself to its straight shape, will be balanced over the whole length of the spiral, apart from the ends of the SMA wire. The contraction of the SMA wire causes the diameter of the wound SMA spiral to be correspondingly smaller.

It is the purpose of the present invention to provide an actuator element, whose function is based on the shape memory effect of an SMA wire, the simple geometric design of the element permitting a profitable mass production.

It is a further purpose of the invention to provide a design of an actuator element, in which the electrical connection of the SMA wire can take place in a simple and reliable manner.

According to the invention, this is achieved by means of an actuator element for generating a force and/or a movement, the element comprising at least one cylindrical rubber part, at least one helical spring and at least one SMA wire wound to a helical shape, the cylindrical rubber part containing over its length a cylindrical cavity, the helical spring and the wound SMA wire being arranged around the cylindrical cavity.

This provides an actuator element that appears as a finished unit that can form part of mechanical devices on a component level and perform an activation function in the form of a linear movement with a simultaneously generated force.

The actuator element according to the invention comprises a concentrically designed cylindrical structure having on the inside a cylindrical cavity that is bounded by the inner diameter and length of the helical spring. A soft and flexible rubber layer is moulded around the helical spring, so that the wire making up the helical spring is embedded in the rubber. An SMA wire can be wound in spiral form around the rubber layer in such a manner that none of the windings are touching. According to an embodiment of the invention, a rubber layer can be moulded around the SMA wire to retain and encapsulated the spiral.

When the SMA wire in the spiral is heated above its phase transformation temperature, it will become 5% shorter, causing the diameter of the SMA spiral to be reduced by 5%. This means that the rubber layer between the wound SMA wire and the helical spring will be compressed with a large force. The helical spring will resist this radial contraction, but will permit an expansion in the axial direction. On a whole, this means that the actuator element will extend in the longitudinal direction and at the same time be able to generate a large force in the longitudinal direction. By varying the relationship between the diameters of the helical spring and the SMA spiral (the wound SMA wire) it is possible to vary the properties of the actuator element in such a manner that with the same external dimensions of the element, it will be possible to provide an actuator element with a large expansion and a smaller force, or a actuator element with a smaller expansion and a large force. Maintaining, for example, the diameter of the SMA spiral and reducing the diameter of the helical spring will provide an actuator element with a smaller expansion and a larger force. On the other hand, a helical spring with a larger diameter will provide an actuator element with a larger expansion and a smaller force.

The correlation between the diameter of the SMA spiral (the wound SMA wire) and the diameter of the helical spring and the longitudinal expansion of a given actuator element can be described by means of the following formula:

$${L}_{2} := \frac{{L}_{1} \cdot ( {D}_{f}^{2} - {D}_{sma}^{2} )}{{D}_{f}^{2} - {D}_{sma}^{2} \cdot {( ds - 1 )}^{2}}$$

$${D}_{f} \text{:} Diameter of helical spring$$

$${D}_{sma} \text{:} Diameter of SMA spiral$$

$${L}_{1} \text{:} Length of non \text{-} activated actuator element$$

$${L}_{2} \text{:} Length of activated actuator element$$

$$ds \text{:} \begin{matrix}Longitudinal change of the SMA wire \\ after the phase transition , 0 \text{-} 8 \% , typically 5 \%\end{matrix}$$

The actuator element has the advantageous function that it can convert the 5% linear contraction in the longitudinal direction of the used, single SMA wire to a 10% to 25% linear expansion in the axial direction of the element.

Further, the actuator element has the advantageous function that the force that can be generated simultaneously with the linear expansion in the axial direction is many-folded in relation to the maximum pulling force of the used, single SMA.

It is a further advantage that, due to its simple geometry and design, the actuator can easily be mass produced. The mass production could, for example, be performed in connection with an injection moulding machine, which could easily be modified to the production of actuator elements of different sizes and lengths.

In a special design of the actuator element in accordance with the invention, the rubber part can be made of concentric structures, comprising, in a radial order starting from the inside, a cylindrical cavity, a rubber layer with embedded helical spring, an intermediate rubber layer, a rubber layer with an embedded, wound SMA wire, and an outer rubber layer.

In a further design of the actuator element according to the invention, the rubber part can be made of concentric structures, comprising, in a radial order starting from the inside, a cylindrical cavity, a rubber layer with an embedded, wound SMA wire, an intermediate rubber layer, a rubber layer with an embedded helical spring, and an outer rubber layer.

With this interchanged arrangement of the helical spring and the wound SMA wire, it is possible to design an actuator element that contracts during heating of the wound SMA wire.

In an alternative embodiment of the actuator element, the rubber part can be made of concentric structures, comprising, in a radial order starting from the inside, a cylindrical cavity, a rubber layer with an embedded, wound SMA wire, an intermediate rubber layer, a rubber layer with an embedded helical spring, a further rubber layer with an embedded, wound SMA wire, and an outer rubber layer.

Further, the actuator element according to the invention can further comprise a rubber layer with an embedded, wound SMA wire, the rubber layer consisting of an electrically conducting rubber.

Further, the actuator element can comprise a rubber layer with an embedded helical spring, the rubber layer consisting of an electrically conducting rubber. The electrically conducting rubber can have an electrical conductivity in the interval from 0.1 S/m to 100 S/m.

Advantageously, the rubber material used for embedding the helical spring and the wound SMA wire can be a silicon rubber or a fluor silicon rubber, as their maximum, continuous application temperature is >200° C. There are different types of commercially available rubber types with different mechanical, thermal and electrical properties. Thus, it is possible to adapt the mechanical and dynamic properties of an actuator element to a specific application by selecting a rubber type with the optimum properties for this application. For example, it will be advantageous to use a soft rubber for an actuator element that is supposed to generate a large expansion and a smaller force. On the other hand, it will be an advantage to use a hard rubber for an actuator element that is supposed to generate a large force and a smaller expansion. If the actuator element needs to be fast, meaning that heating and cooling of the SMA wire must be fast, it will be an advantage to use a rubber with a high heat conduction capacity (>0.2 W/(mK)).

The wound SMA wire can be a nickel titanium (NiTi) wire.

If the actuator element is to be activated by joule heating, that is, the wound SMA wire is heated by an electrical current running through it, the electrical connection of the ends of the SMA wire to a voltage source can take place by means of soldering, welding, gluing or crimping, but it will be advantageous to use two types of rubber, namely a soft, electrically isolating rubber for performing the mechanical function in the actuator element and an electrically conducting rubber for making the termination to the SMA wire. The electrically conducting rubber can form part of the concentric structure of the element in the form of a thin-walled tube, in which the wound SMA wire is embedded and a thin-walled tube, in which the helical spring is embedded.

The actuator element according to the invention, comprising a soft, electrically isolating rubber and an electrically conducting rubber, can consist of a concentrically designed, cylindrical structure having at the inside a cylindrical cavity that is delimited by the inner diameter and the length of a helical spring. Around the helical spring is moulded an electrically conducting rubber layer, so that the wire forming the helical spring is embedded by the rubber. Around the electrically conducting rubber layer with the embedded helical spring is moulded a soft, electrically isolating rubber layer. Around the soft, electrically isolating rubber layer is moulded an electrically conducting rubber layer with an embedded, wound SMA wire, meaning that the wire forming the SMA spiral is surrounded by the rubber. Around the electrically conducting rubber layer with the SMA spiral is moulded a soft, electrically isolating rubber layer.

One of the advantages of embedding the wound SMA wire in an electrically conducting rubber layer is that, if the SMA wire should break in the course of the life of the actuator element, this would only have an insignificant influence on the function of the actuator element.

The electrical connection to the ends of the actuator element can advantageously take place by means of two discs, between which the actuator element is constrained. One disc can be made of an electrically isolating material having on one side two concentric contact faces of an electrically conducting material, for example copper. The two contact faces can be shaped and arranged in such a manner that the inner one only gets in contact with the electrically conducting rubber layer embedding the helical spring, and the outer one only gets in contact with the electrically conducting layer embedding the wound SMA wire, when one of the ends of the actuator element is pressed against the disc. The other disc is made of an electrically isolating material having on one side a contact face that is shaped and arranged so that the two electrically conducting rubber layers get in electrical contact with each other, when one of the ends of the actuator element is pressed against the disc. When an actuator element, which is constrained in this way, must be brought to activation, it can be done by applying an electrical voltage across the contact faces on the first disc. This will cause a current to run through the electrically conducting rubber layer embedding the wound SMA wire. The SMA wire will be heated and undergo a phase transformation. The current will run back to the first disc via the contact face on the other disc and the electrically conducting rubber layer embedding the helical spring.

In order to obtain an advantageous function from the electrically conducting rubber layer, the electrical conductivity of the rubber material can advantageously be in the range from 0.1 S/m to 100 S/m, the range around 1 S/m being most advantageous.

It is a practical advantage that the electrical connection to the actuator element can take place from one end of the actuator element.

Further, according to the invention, the above described electrical connection of the actuator element has the advantage that several actuator elements can be assembled to one actuator. This can be done by stacking two or more actuator elements in series between two connection discs, thereby achieve activation with a longer total linear movement.

When the actuator element is in the heated state, that is, the SMA wire has undergone a complete or partial transformation to the austenitic phase; the SMA material in the SMA wire behaves like a super-elastic material. A super-elastic material is characterised by being able to undergo a large deformation, up to 10%, which is reversible. The fact that the SMA wire becomes super-elastic makes the actuator element more resistant to external applied mechanical energy in the form of blows or vibrations. The external applied mechanical energy will be converted to a thermal energy by the super-elastic SMA wire. Thus, in the heated state, the actuator element according to the invention can advantageously form part of an active or passive vibration damper. By selecting an SMA wire with a low transformation temperature, for example 0° C., and a high hysteresis, it is possible to make an actuator element for a passive vibration damper that can function over a large temperature range, for example from 0 to 100° C.

An actuator element according to the invention can advantageously form part of a bending actuator, if a limitation is placed in the longitudinal direction of the actuator element, the limitation having a design that prevents the element from expanding into the area of the limitation, meaning that during activation the element will bend. The limitation is placed in one side, so that during activation the actuator element is prevented from a longitudinal expansion in the side, where the limitation is placed, and the actuator element will automatically bend.

According to the invention, the limitation can be achieved by means of an external arrangement or by means of an internal arrangement that is embedded in the rubber together with the helical spring and/or the wound SMA wire. According to the invention, the limitation can be one or more s wire embedded in the rubber between the wound SMA and the helical spring. The wires can be arranged in one side of the actuator element and extend in parallel with the longitudinal axis of the actuator element. When the actuator element is activated, a longitudinal expansion will only take place in the side comprising no wires, and the actuator element will bend.

The actuator element according to the invention can advantageously be part of a rotating actuator, in which the axial expansion is converted to a rotation of the whole actuator element around its longitudinal axis. This can be achieved by means of an external arrangement or by means of an internal arrangement that is embedded in the rubber together with the helical spring and/or the wound SMA wire. The arrangement could, for example, have the form of one or more s wires embedded in the rubber between the wound SMA wire and the helical spring. The embedded wires can extend in the longitudinal direction of the actuator element in the form of a spiral, so that their ends are twisted by, for example, 120°. When the actuator element is activated, the longitudinal expansion of the actuator element will cause the wires to straighten out to extend approximately in parallel with the longitudinal axis of the actuator element, and at the same time the actuator element will rotate around its longitudinal axis.

The present invention can advantageously be used on a component level in different devices, for example:
As an actuator element in a thermostat. The linear movement of the actuator element can be used to open and close a valve.
As an actuator element in a linear actuator, where an actuator made of one or more elements can replace an electrical spindle actuator, a pneumatic cylinder or a hydraulic cylinder. The typical use would be an application needing a large force and a linear movement of 5% to 25%, and an activation frequency of less than 1 Hz.
As an actuator in consumer goods, where the low manufacturing cost, the silent function and the easy implementation will be advantageous.
As an actuator in hand tools, where a large force is needed and the total weight of the tool is important. Examples could be hand tools with a cutting/pressing function or a pulling function, for example rivet tools and nail guns.
In actuators within the transportation field, for example cars, planes and ships, where the low weight in relation to the force supplied by the actuator element is an advantage.
In actuators in the field of robot technology.
As actuator elements in different types of valves.
As actuator elements in small pumps, where the silent function and high power density will be advantageous.

Another aspect of the invention is an actuator that comprises an actuator element according to the invention, the actuator element being suspended between two discs comprising electrical contact faces.

Further, the actuator according to the invention can have a central guide around a central tube and a central rod.

Additionally, the actuator according to the invention can comprise at least one slide bearing attached to the central tube.

The actuator according to the invention can comprise at least one slide bearing attached to the central rod.

Further, the actuator according to the invention can comprise at least one spring in the central guide.

### BRIEF DESCRIPTION OF THE DRAWINGS

In the following, the invention is explained in detail with reference to the drawings, showing:

FIG. 1 an example of an actuator element according to the invention, the drawing showing cross-sections through the actuator element in the non-activated state and in the activated state;

FIG. 2 an example of an actuator element, in which the SMA wire is electrical connected by means of an electrically conduction rubber, the drawing showing a cross-section of the actuator element and a cross-section of two actuator elements, which are stacked and electrical connected between two discs;

FIG. 3 an example of an actuator according to the invention, said actuator comprising an actuator element;

FIG. 4 an example of a bending actuator element, the drawing showing cross-sections of a bending actuator element in the non-activated state and in the activated state;

FIG. 5 an example of a rotating actuator element, the drawing showing cross-sections of a rotating actuator element in the non-activated state and in the activated state;

FIG. 6 an example of an actuator element used in a pump, the drawing showing cross-sections of a pump with an activated actuator element and a non-activated actuator element;

FIG. 7 an example of two actuator elements used in a pump, the drawing showing cross-sections of the pump with either one or the other actuator element in the activated state.

### DETAILED DESCRIPTION

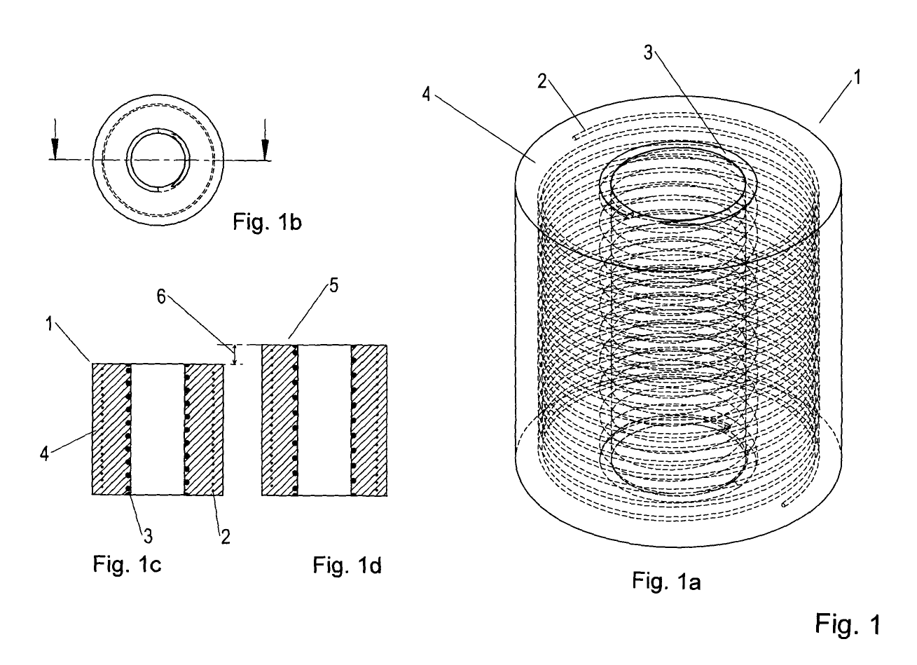

FIG. 1 shows an actuator element 1 according to the invention, comprising a tube-shaped rubber part 4 that embeds an SMA wire 2 that is wound in a helical shape and a helical spring 3. FIG. 1a shows a perspective view of the actuator element, wherein the rubber part is transparent. FIG. 1b shows a top view of the actuator element. FIG. 1c shows a cross-sectional view through the actuator element in the non-activated state. FIG. 1d is a cross-sectional view of the actuator element in the activated state. When the SMA wire 2 undergoes a phase transformation to an austenitic structure, the SMA wire 2 will contract; meaning that the diameter of the SMA windings get smaller and the tube-shaped rubber part 4 is compressed radially. This causes the actuator element 1 to go to the activated state 5 causing an expansion 6 of the length of the tube-shaped rubber part 4.

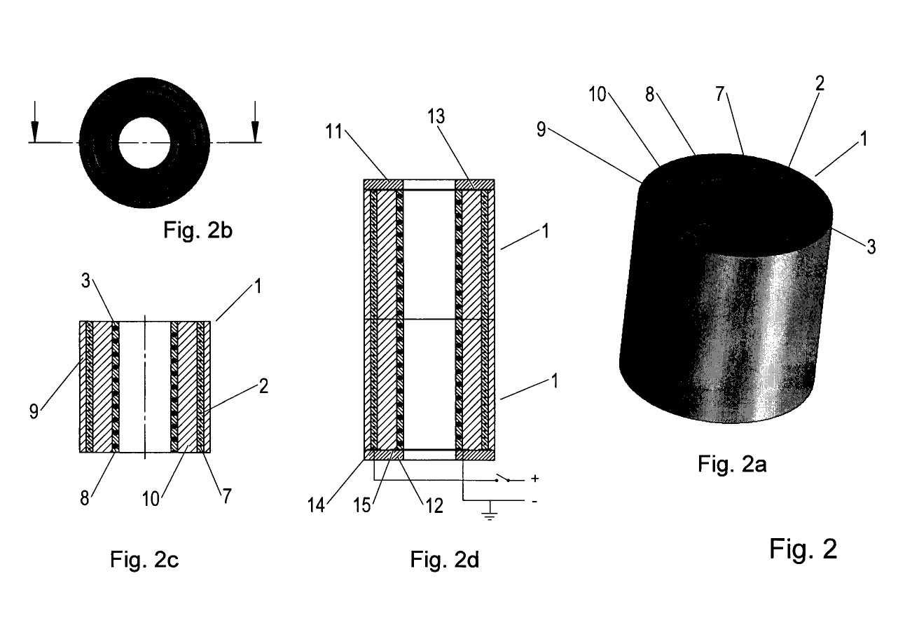

FIG. 2 shows an actuator element 1 according to the invention that comprises four tube-shaped rubber parts 7, 8, 9, 10, which are assembled in a concentric structure. The concentric structure comprise in a radial order starting from the inside, of a helical spring 3 embedded in an electrically conducting rubber 8, a tube-shaped rubber part 4 made of a soft rubber, a wound SMA wire 2 embedded in an electrically conducting rubber 7 and a tube-shaped rubber part 9 made of a soft rubber. FIG. 2a shows a perspective view of the actuator element. FIG. 2b shows a top view of the actuator element. FIG. 2c shows a cross-sectional view through the actuator element. FIG. 2d shows two actuator elements 1 of the type described stacked between two discs 11, 12. The bottom disc 12 contains an electrically isolating material and has on its one side two concentric contact faces 14, 15 made of copper. The top disc 11 consists of an electrically isolating material and has on its one side a concentric contact face 13, for example made of copper. When an electrical voltage is applied across the contact faces 14, 15, a current will run from the outer contact face 14, through the SMA wire 2 and the electrically conducting rubber in the two tube-shaped rubber parts 7 to the concentric contact face 13 on the top disc 11, through the two helical springs 3 and the electrically conducting rubber surrounding them and back to the inner contact face 15 on the bottom disc 11.

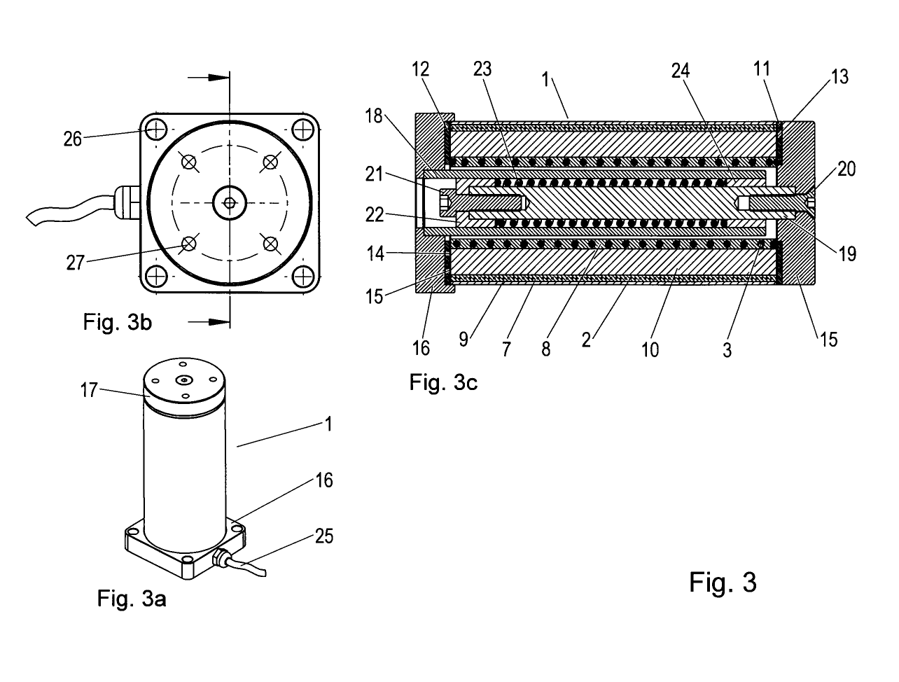

FIG. 3 shows an example of an actuator according to the invention. FIG. 3a shows an external view of the actuator. FIG. 3b shows a top view of the actuator. FIG. 3c shows a cross-sectional view of the actuator. The actuator comprises an actuator element 1 with a diameter of 50 mm and a length of 100 mm. The actuator element 1 comprises 9.7 m of 0.5 mm SMA wire 2 embedded in an electrically conducting rubber 7, a helical spring 3 made of a 2 mm wire of a hard copper alloy embedded in an electrically conducting rubber 8 and two tube-shaped rubber parts 9, 10 made of soft rubber. An actuator element 1 of this size is able to generate a linear movement of 15 mm in the axial direction and a force of 2000 N.

The actuator element is constrained between a bottom disc 12 and a top disc 11, which are made of the fibre glass composite material FR4. One side of the top disc 11 comprises a concentric contact face 13 made of 0.1 mm copper that creates an electrical contact between the two tube-shaped rubber parts 7, 8. One side of the bottom disc 12 comprises an outer concentric contact face 15 and an inner concentric contact face 14 made of 0.1 mm copper that create electrical contact on the one hand to the tube-shaped rubber part 7 that embeds the SMA wire 2 and on the other hand to the tube-shaped rubber part 8 that embeds the helical spring 3. The two concentric contact faces 14, 15 on the bottom disc 12 are electrically connected to a cable 25.

Via the bottom disc 12 and the top disc 11, the force and the movement generated by the actuator element are transferred to the bottom plate 16 and the top plate 17. A central tube 18 that is attached to the centre of the bottom plate 16 extends almost all the way through the actuator element 1 and has an outer diameter that is slightly smaller than the inner diameter of the actuator element 1. Inside the end of the central tube 18 is attached a slide bearing 24, in which the central rod 19 that is attached to the top plate 17 by means of a bolt 20 can reciprocate inside the central tube, when the actuator element 1 is activated. At the end of the central rod 19 a slide bearing 22 is attached by means of a bolt 21, said slide bearing 22 reciprocating inside the central tube 18, when the actuator element 1 is activated. A biasing spring 23 is suspended between the two slide bearings 22, 24 and has the function of contracting the actuator element 1, when it has been activated without a counter-force. The bottom plate 16 and the top plate 17 comprise a number of holes 26, 27 for assembly purposes.

The actuator is activated in that the two concentric contact faces 14, 15 are connected to an electrical voltage source by means of the cable 25. The voltage source can be DC or AC. When an electrical voltage is applied across the contact faces 14, 15, an electrical current will run from the outer contact face 14, through the wound SMA wire 2 and the electrically conducting rubber in the tube-shaped rubber part 7, to the concentric contact face 13 on the top disc 11 and from here through the helical spring 3 and the electrically conducting rubber 8 embedding it, and from here back to the inner contact face 14 of the bottom disc 12. The electrical resistance from the wound SMA wire 2 together with the electrical current running through the wound SMA wire 2 will cause a heating of the material of the wire. When the temperature of the SMA material exceeds the phase transformation temperature for the SMA material in question, the SMA wire will contract and the diameter of the SMA windings 2 will become smaller. When the diameter of the SMA windings gets smaller, the tube-shaped rubber part 4 will contract radially, meaning that the whole actuator element will expand in parallel to the longitudinal axis of the actuator element. When the actuator element expands, the distance between the bottom plate 16 and the top plate 17 gets longer, so that the central rod 19 is pulled out of the central tube 18 causing a reduction of the distance between the slide bearings 22, 24 so that the biasing spring 23 is compressed. When all the SMA material of the SMA wire 2 has gone through a phase transformation, the actuator element 1 and thus the whole actuator will have reached its maximum length. When the voltage to the actuator is disconnected, the SMA material in the wound SMA wire 2 will start cooling off. When the temperature gets below the phase transformation temperature, the SMA material in the wound SMA wire 2 will start transforming back to its martensitic phase, meaning that the diameter of the SMA windings 2 will gradually increase until it has reached the original size before the heating. The force for pressing the wound SMA wire 2 back to its original diameter comes from the constrained biasing spring 23, when an external force is not available.

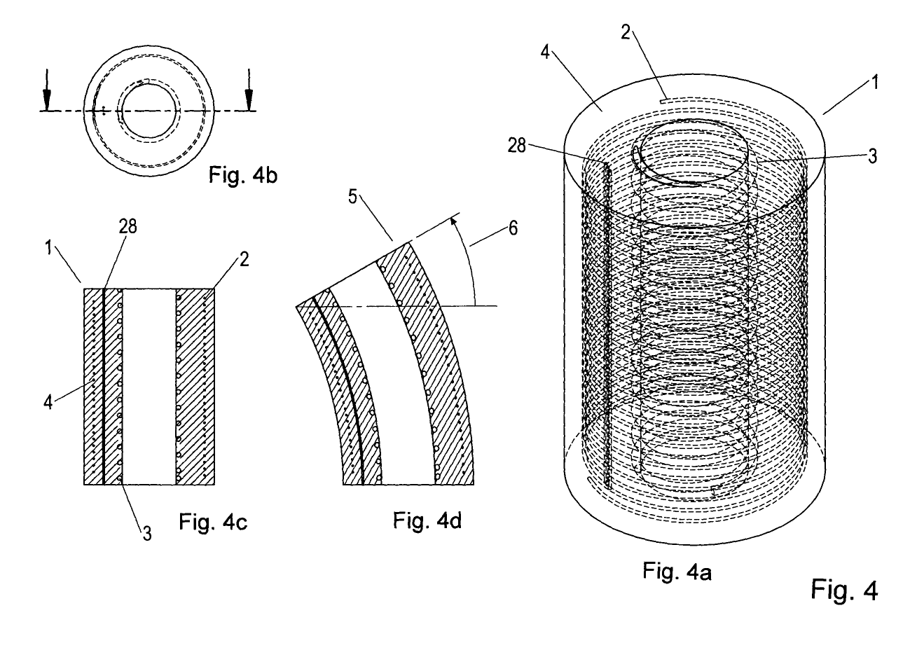

FIG. 4 shows a bending actuator element 1 that comprises a tube-shaped rubber part 4 embedding an SMA wire 2 wound in a helical shape, a helical spring 3 and, at one side of the rubber part 4, three wire 28. FIG. 4a shows a perspective view of a bending actuator element, wherein the rubber part 4 is transparent. FIG. 4b shows a top view of the bending actuator element. FIG. 4c shows a cross-sectional view of a bending actuator element in the non-activated state. FIG. 4d shows a cross-sectional view of a bending actuator element in the activated state. When the SMA wire 2 undergoes phase transformation, the SMA wire will contract causing a reduction of the SMA spiral diameter, so that the tube-shaped rubber part 4 is radially compressed and bends because its length expansion in one side is limited by the wires 28. This causes the bending actuator element 1 to go to the activated state 5, where an angle bending 6 of the tube-shaped rubber part 4 takes place.

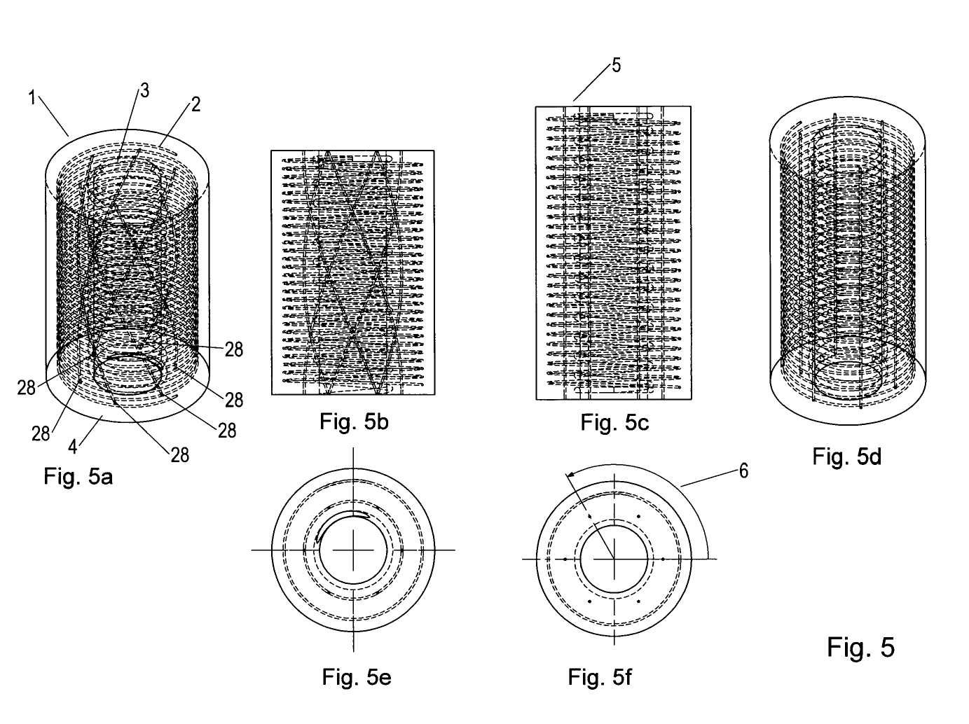

FIG. 5 shows a rotating actuator element 1 comprising a tube-shaped rubber part 4 embedding a wound SMA wire 2, a helical spring 3 and six 120° helically wound wire 28. FIG. 5a shows a perspective view of the rotating actuator element, wherein the rubber part 4 is transparent. FIG. 5e is a top view of the rotating actuator element in the non-activated state. FIG. 5b is a cross-sectional view of the rotating actuator element in the non-activated state. FIG. 5f is a top view of the rotating actuator element in the activated state. FIG. 5c is a cross-sectional view of the rotating actuator element in the activated state. FIG. 5d shows a perspective view of the rotating actuator element, wherein the rubber part 4 is transparent. When the SMA wire 2 undergoes a phase transformation to the austenitic structure, the SMA wire 2 will contract causing the SMA spiral diameter to decrease. This will cause a radial compression of the tube-shaped rubber part 4, whose longitudinal extension increases. The six helically wound wire 28 have a length that corresponds to the length of the fully extended tube-shaped rubber part 4. This causes them to be straightened and to becoming approximately parallel to the longitudinal axis of the tube-shaped rubber part 4. This will cause the actuator element 1 to rotate 6 around its longitudinal axis, when the actuator element 1 goes to its activated state.

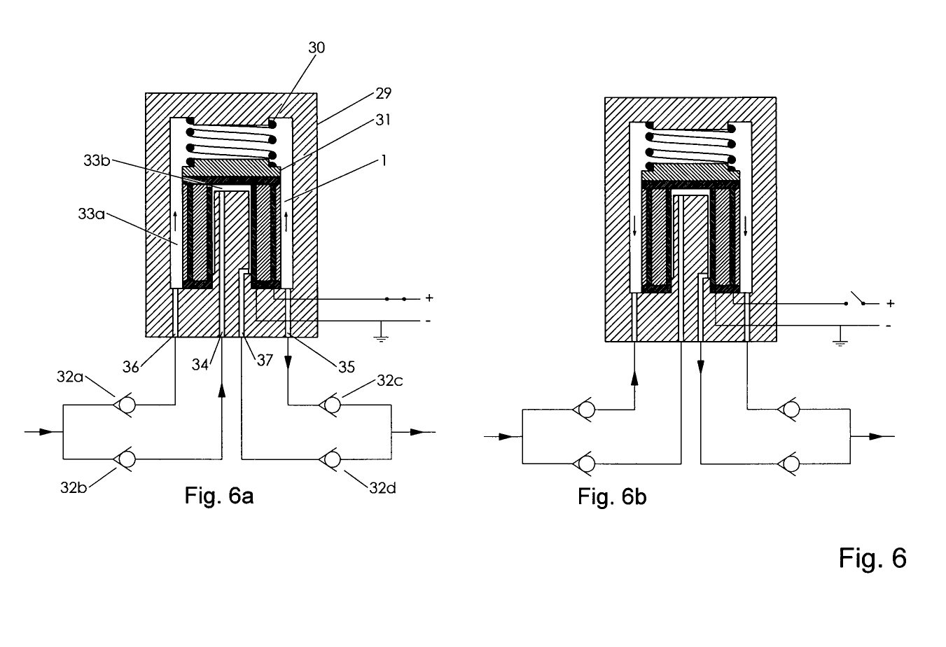

FIG. 6 shows a liquid pump. FIG. 6a shows what happens, when the pump is connected to an electrical voltage source and the actuator element is activated. FIG. 6b shows what happens when the pump is disconnected from the electrical voltage source and the actuator element is deactivated. The pump comprises a pump housing 29 in which an actuator element 1, a return spring 30 and a spring holding plate 31 are arranged. Externally, two sets of non-return valves 32a-d are connected to the pump housing with the purpose of leading liquid to and from the pump, and an electrical voltage source that can be connected to the actuator element 1. The actuator element divides the liquid volume in the pump housing 29 into two parts, an outer volume 33a and an inner volume 33b, each volume being connected to the non-return valves via an inlet channel and an outlet channel. When the external voltage source is connected to the actuator element 1, the actuator element will be activated, thus expanding in the longitudinal direction, shown in FIG. 6a by means of upwardly pointing arrows. This causes the return spring 30 to contract and the outer volume 33a gets smaller and the inner volume 33b gets larger. This causes liquid to flow to the inner volume 33b via the non-return valve 32b and the inlet channel 34, and to flow from the outer volume 33a via the outlet channel 35 and the non-return valve 32c. When the connection to the external voltage source is disconnected, corresponding to the situation shown in FIG. 6b, the actuator element 1 is deactivated and the return spring 30 forces the actuator element 1 back to its original length, shown in FIG. 6b by means of downwardly pointing arrows, causing the outer volume 33a to grow and the inner volume 33b to get smaller. This causes liquid to flow to the outer volume 33a via the non-return valve 32a and the outer inlet channel 36, and to flow away from the inner volume 33b via the inner outlet channel 37 and the non-return valve 32d. A cyclic connection and disconnection of the external voltage source will thus cause the liquid pump to perform a continuous pump function.

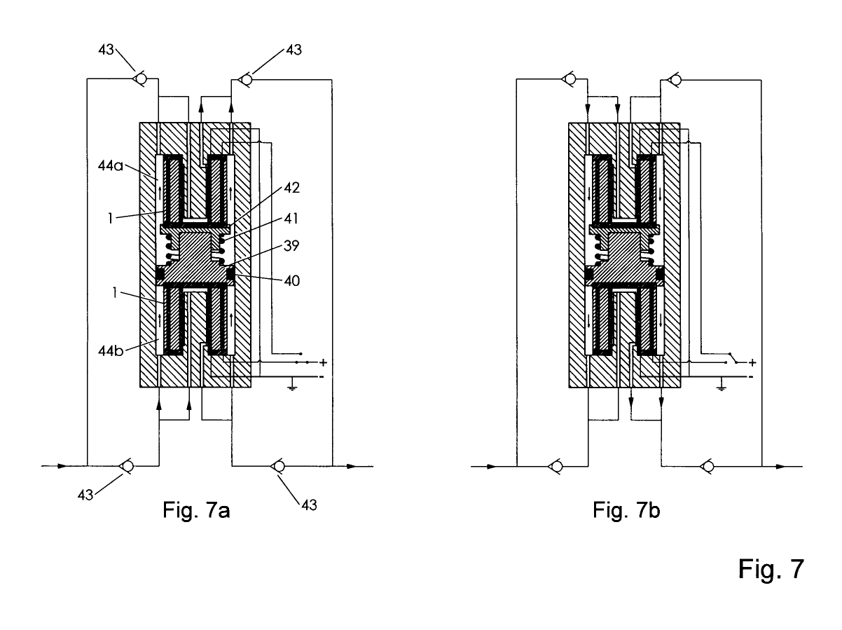

FIG. 7 shows a liquid pump comprising a pump housing 38 that comprises two actuator elements 1, a pump piston 39, a piston sealing 40, a biasing spring 41 and a spring holding plate 42. Externally, two sets of non-return valves 43 with the purpose of leading liquid to and from the pump, and an external electrical voltage source that can alternatingly be connected to the two actuator elements 1, are connected through the pump housing. The pump piston 39 with the piston sealing 40 divides the liquid volume in the pump housing into two parts, a top volume 44a and a bottom volume 44b. Each volume is connected to the non-return valves via an inlet channel and an outlet channel. The biasing spring 41 has the function of biasing the two actuator elements 1 when the pump is not in the pumping function, that is, when both actuator elements 1 are not activated. When the pump is in the pumping function, the electrical voltage source changes between connection to one or the other of the two actuator elements 1, which are alternatingly expanded and contracted. This causes the pump piston to reciprocate in the pump housing 38 and alternatingly increasing or decreasing the top volume 44a and the bottom volume 44b, so that liquid will alternatingly flow from and to the top volume 44a and the bottom volume 44b. The liquid flowing alternatingly from and to the top volume 44a (see FIG. 7a) and the bottom volume 44b (see FIG. 7b) will be rectified by the non-return valves, so that it flows through the pump. Cyclically switching the external voltage source between the two actuator elements 1 will thus cause the liquid pump to perform a continuous pumping function. FIG. 7a shows the situation, in which the actuator in the bottom is activated. FIG. 7b shows the situation, in which the actuator element in the top is activated.

Although various embodiments of the present invention have been described and shown, the invention is not restricted thereto, but may also be embodied in other ways within the scope of the subject-matter defined in the following claims.

What is claimed is:

1. An actuator element for generating a force and/or a movement, the element comprising at least one cylindrical rubber part, at least one helical spring and at least one SMA wire wound to a helical shape, the cylindrical rubber part having in its longitudinal direction a cylindrical cavity, the helical spring and the wound SMA wire being arranged around the cylindrical cavity.

2. The actuator element according to claim 1, wherein the actuator element comprises concentric structures, in radial order starting from the inside, the helical spring, a rubber layer embedding the helical spring and the SMA wire being arranged around the rubber layer.

3. The actuator element according to claim 1, wherein the SMA wire is embedded in a rubber layer.

4. The actuator element according to claim 3, wherein an intermediate rubber layer is placed between the rubber layer with the helical spring and the rubber layer with the SMA wire.

5. The actuator element according to claim 2, wherein an outer rubber layer covers the SMA wire or the rubber layer embedding the SMA wire.

6. The actuator element according to claim 1, in which the rubber part is made of concentric structures comprising, in radial order starting from the inside, a cylindrical cavity, a rubber layer embedding the helical spring, an intermediate rubber layer, a rubber layer embedding the wound SMA wire and an outer rubber layer.

7. The actuator element according to claim 1, in which the rubber part is made of concentric structures comprising, in radial order starting from the inside, a cylindrical cavity, a rubber layer embedding the wound SMA wire, an intermediate rubber layer, a rubber layer embedding the helical spring and an outer rubber layer.

8. The actuator element according to claim 1, in which the rubber part is made of concentric structures comprising, in radial order starting from the inside, a cylindrical cavity, a rubber layer embedding the wound SMA wire, an intermediate rubber layer, a rubber layer embedding the helical spring, a further rubber layer embedding a wound SMA wire and an outer rubber layer.

9. The actuator element according to claim 3, in which the rubber layer embedding the wound SMA wire is made of an electrically conducting rubber.

10. The actuator element according to claim 2, in which the rubber layer embedding the helical spring is made of an electrically conducting rubber.

11. The actuator element according to claim 9, in which the electrically conducting rubber has an electrical conductivity in the interval from 0.1 S/m to 100 S/m.

12. The actuator element according to claim 1, wherein the wound SMA wire is a nickel-titanium (NiTi) wire.

13. A liquid pump with a pump housing comprising an actuator element according to claim 1 and a return spring.

14. A liquid pump with a pump housing comprising two actuator elements according to claim 1, wherein the two actuator elements alternatingly expand and contract.

15. A vibration damper for damping vibrations, wherein the damper comprises an actuator element according to claim 1.

16. The actuator element according to claim 1, wherein a limitation is arranged in the longitudinal direction of the actuator element, the limitation being formed so that during activation it prevents the element from expanding in the area of the limitation, thus causing the element to bend during activation.

17. The actuator element according to claim 16, wherein the limitation comprises an internal arrangement embedded in the rubber layer.

18. The actuator element according to claim 17, wherein the limitation consists of one or several wires.

19. The actuator element according to claim 17, wherein the limitation is placed in the longitudinal direction of the actuator element between the SMA wire and the helical spring.

20. The actuator comprising at least one actuator element according to claim 9, wherein the actuator element is constrained between two discs, on which electric contact faces are attached.

21. The actuator according to claim 20, wherein the actuator has a central guide comprising a central tube and a central rod.

22. The actuator according to claim 21, wherein at least one slide bearing is attached to the central tube.

23. The actuator according to claim 21, wherein at least one slide bearing is attached to the central rod.

24. The actuator according to claim 20, wherein the central guide comprises at least one spring.
